(19) United States
(12) Patent Application Publication
(10) Pub. No.: US 2026/0225846 A1
(43) Pub. Date: Aug. 6, 2026

(54) AN ARRANGEMENT FOR CONTROLLING A PATH OF A MATERIAL DURING TRANSFERRING AND A METHOD THEREOF

(71) Applicant: SPINNOVA OYJ, Jyväskylä (FI)

(72) Inventors: Markko MYLLYS, Jyväskylä (FI); Juha SALMELA, Jyväskylä (FI); Pasi SELENIUS, Jyväskylä (FI); Markku KATAJA, Jyväskylä (FI)

(21) Appl. No.: 19/155,000

(22) PCT Filed: Jan. 30, 2024
(86) PCT No.: PCT/FI2024/050037

§ 371 Date: Aug. 8, 2025

(30) Foreign Application Priority Data
Feb. 8, 2023 (FI) 20235124

(51) Int. Cl. B65H 51/16; B65H 51/005; B65H 51/015

(52) U.S. Cl. CPC B65H 51/16; B65H 51/005; B65H 51/015; B65H 2701/31

(57) ABSTRACT

An arrangement for controlling a path of material, such as filaments comprises at least one fluid flow providing device. The one fluid flow providing device comprises an input for receiving pre-fluid flow, and an output for providing and focusing a high-speed fluid flow towards the material during the transportation of the material. The speed of the high-speed fluid flow is higher than a transferring speed of the material, whereupon a velocity gradient of the high-speed fluid flow induces a force, which drags the material towards a maximum of said velocity gradient and thereby change the path of the material.

### TECHNICAL FIELD OF THE INVENTION

The invention relates to an arrangement and a method for controlling a path of a material during transferring the material. In particularly, the invention relates to an arrangement and a method for controlling the path in a contactless manner.

### BACKGROUND OF THE INVENTION

Different kinds of methods and systems are known to controlling a path of a material during transferring the material, such as mechanical guiding devices or deflectors. However, there are some disadvantages related to the known mechanical guiding devices or deflectors, namely they always have mechanical contact with the material, which might cause damage to the material or if the material is light for example, such as filaments or filament fibers, the material may get stuck to structures of the mechanical guiding devices or deflectors. In addition, also fans, air flows or air blasts are used especially for light materials to transfer collectively an airmass and thus the material via said transferred airmass. This kinds of airmass transferring devices are typically inaccurate and use a lot of pressurised air, which is a big energy saving question especially in a large-scale production, because a production of pressurized air is quite ineffective in view of an energy consumption.

### SUMMARY OF THE INVENTION

An object of the invention is to alleviate and eliminate the problems relating to the known prior art. Especially the object of the invention is to provide an arrangement and method for controlling a path of a material during transferring the material in an accurate and energy saving way. In particular, the object of the invention is to control the path of light material, such as filaments transferred by a conveyor, in a contactless manner.

The object of the invention can be achieved by the features of independent claims.

The invention relates to an arrangement for controlling a path of material according to claim 1. In addition, the invention relates to a method for controlling a path of material according to claim 15.

According to an embodiment of the invention an arrangement for controlling a path of material or filaments comprises a fluid flow providing device for providing and focusing a high-speed fluid flow towards the material transferred by the transferring device. According to an advantageous embodiment of the invention the speed of the high-speed fluid flow is configured to be higher than a transferring speed of the material, whereupon a velocity gradient of the high-speed fluid flow is configured to induce a force to drag the material towards a maximum of the velocity gradient and thereby change the path of the material in a desired manner. In addition, the velocity gradient of high-speed fluid flow causes compressing of the material, such as filaments, closer to each other or towards the maximum of the velocity gradient of the high-speed fluid flow.

According to an embodiment the arrangement may comprise a number of the fluid flow providing devices, and in addition the fluid flow providing device may also comprise one or more outputs to provide and focus a number of the high-speed fluid flows towards the material. In addition, according to an example the initial speed of the high-speed fluid flow at the output of the fluid flow providing device or the impact velocity the high-speed fluid is hitting the material is advantageously at least two times, advantageously 3-5 times, or even most advantageously over 5 times the velocity of the transferring speed of the material. According to an example, the flow rate of the fluid flow provided by the fluid flow providing device is controllable and the speed of the high-speed fluid flow is at a range of 50-330 m/s, more advantageously 50-200 m/s or 100-150 m/s, whereupon the transferring speed of the material is typically 10-20 m/s in the transferring direction, or a first direction, of a travel of the transferring device. However, these are only examples, and the invention is not limited to those only, and in some examples, density of the high-speed fluid flow and density of the material the path of which is to be controlled may have an effect for choosing a suitable speed difference for the velocity of the high-speed fluid (and/or the velocity of the transferring speed of the material). For example, the denser the high-speed fluid flow, the slower the velocity of the high-speed fluid flow can be, such as only 2-5 times the velocity of the transferring speed of the material. An angle by which the high-speed fluid flow hits the transferring direction of the material can be varied depending on the needs. It may be for example perpendicular to or at deviating from the transferring direction (the first direction) or having components to the same direction with the transferring direction of the material. If the angle of attack is essentially zero degree, an ejector effect can be achieved and thus both to induce the force to drag the material towards the maximum of the velocity gradient of the high-speed fluid flow as well as accelerate the transferring speed of the material.

According to an example, the material comprises filaments and the filaments are transferred by a belt conveyor. The belt conveyor may also heat and/or dry the filaments at the same, so during the transferring. According to the invention, the path of the filaments may thus be controlled by the high-speed fluid by providing and focusing the high-speed fluid at an angle to or along and parallel to a surface of the belt conveyor carrying the filaments. However, according to the invention the high-speed fluid flow can also be used for controlling the path of the filaments being or transferred in the air. In fact, the high-speed fluid flow can be used to detach the filaments or material from the surface of the transferring device or lift into the air, whereafter the high-speed fluid flow can be used for controlling the path of the material travelling in the air. It is to be noted that the belt conveyor is only one example of the transferring device, and the transferring device can be implemented also by other ways, such as by a rotating cylinder or the like.

In addition, the material flow, such as the filaments transferred, is advantageously continuous so when some portion of the material is deflected the rest will easily “follow” the previous deflected portion of the material. For example, if compared to granular materials, the continuous material flow will typically travel with a slower speed than high-speed fluid flow and will be easily entrained towards a maximum of the velocity gradient of the high-speed fluid flow, whereas the granular material will easily be accelerated essentially to the same velocity of the high-speed fluid flow, whereupon the velocity gradient and also dragging force effect disappears. According to the invention, the fluid flow providing device may comprises a pipe with an input for receiving fluid flow, one or more outputs, and an inner fluid conduit from the input to the outputs. The outputs may be implemented e.g. by capillary tubes extending from the pipe and/or by capillary holes extending from the conduit and through a pipe wall to an outer surface of the pipe. As an example, the outputs may be arranged e.g. in every 1-5 cm, advantageously around every 2 cm along the pipe. The pipe may have e.g. a relatively thick wall (compared to the diameter of the holes), whereupon the holes can be manufactured so that they have accurate focusing effect, for example. In addition, the holes or capillary tubes may be arranged in a certain angle in relation to a longitudinal axis of the pipe, such as 15° to 45°. However, it is to be noted that the angle of attack is independent of the angle of the capillary tubes or holes in relation to the longitudinal axis of the pipe and the angle of attack is determined by the position of the fluid flow providing device in relation to the transferring device and the material transferred.

According to advantageous embodiments of the invention, the output of the fluid flow providing device has an inner diameter of 0,5-5 mm, advantageously 0,8-2 mm, and most advantageously 0,8-1,0 mm. This offers clear advantages, namely when the inner diameter is in the above-mentioned range, the focus of the high-speed fluid flow is very accurate, as well as the speed of the high-speed fluid flow can be kept very high. In addition, when the inner diameter is in the above-mentioned range, also the diameter of the high-speed fluid flow is small compared to the operational scale, and thus very accurate and specific controlling of the path can be done. Moreover, when the diameter of the high-speed fluid flow is small, the volume flow and thus the consumption of the fluid used for the high-speed fluid flow can be kept at a very low level, but also the sharp high-speed fluid flow does not interfere the environment of the material, the path of which is to be under controlling. Therefore, the overall system is very effective but energy efficient.

Still, when the volume flow is quite low, also the momentum of the high-speed fluid flow is relatively low, whereupon the speed of the high-speed fluid flow decreases fast, and, according to the invention the speed of the high-speed fluid flow is smaller than the speed of the material at 10 cm, more advantageously 20 cm and most advantageously 50 cm from the output of the fluid flow providing device. Here the speed of the material is the speed induced by the moving transferring device (in a first direction), which also transfers the material. However, it is to be noted that when the material, in particular very light material like filament(s), is controlled, even the low momentum high-speed fluid flow is effective enough when it transfers its momentum to the very light material. For example, even if the high-speed fluid flow fades out very fast and within a relative short distance, the filaments, for example, will fly or will be transferred much longer due to the momentum transfer from the high-speed fluid flow to the filaments. It is to be noted that according to the invention the volume flow, and thus also the momentum of the high-speed fluid flow, can be controlled e.g. by controlling the velocity or density of the high-speed fluid flow, for example.

In addition, the fluid flow can also control the path of the material very accurately and in a desired way, namely the fluid flow gives an impact to the like filaments so that the filaments tend to continue their path to the direction induced by the fluid flow. It has been noticed that without the fluid flow controlling according to the invention, the tiny and very light filaments may easily float to and in an air current around, namely there are almost always some kind of air currents due to moving transferring device and temperature differences, for example.

The output may just be implemented by a uniform capillary tube or hole with essentially constant diameter, or the output may have a varying inner diameter. The output may be implemented also e.g. by a nozzle type structure, such as a compressed air nozzle. The nozzle may comprise e.g. a conical inner structure so that the inner diameter of the nozzle narrows towards the flow direction. Thus, the nozzle can be used for example for controlling the direction and/or speed of the fluid flow more accurately. In addition, the direction of the output may be controllable, for example manually or the output may be provided by a microcontroller so to change the direction. The controlling of the output may be implemented independently from each other, or all the outputs may be controlled at the same. An arrangement of any previous claims, wherein a direction of the flow of at least one the outputs of the fluid flow providing device is controllable to provide the high-speed fluid with a certain angle of attack in relation to a direction of travel of the transferring device or material transferred. According to an embodiment, the fluid flow providing device may comprise a socket and a ball shaped nozzle with the output, where the nozzle is arranged to the socket so that the ball shaped nozzle and thus the direction of the output of the ball shaped nozzle can be controlled.

Further, the arrangement may comprise outputs with different diameters. According to an example, the smaller diameter outputs are arranged in a downstream direction of the travel of the transferring device and the greater diameter outputs are arranged in an upstream in the direction of the travel of the transferring device. This offers bigger changes to the path especially in the upstream and more accurate controlling to the downstream, but naturally the system can be arranged in opposite way if needed. In addition, the smaller diameters in the downstream portion can cause increasing velocity gradient in the direction of the travel and thus e.g. a stretching effect to the material.

Furthermore, according to an embodiment, the high-speed fluid flow can also be used as a carrier flow fluid for additives, such as ions, plasma, additives, dyes and/or functional additives or other additives. This offers additional advantage, namely the material can be manipulated in a controlled manner by the additives, but at the same the additives can be guided in a controlled manner to the same location as the material, such as filaments, are transferred.

The present invention offers clear advantages, such as an accurate, effective, and contactless way to control the path of the material. According to the invention, it is not the purpose that the high-speed fluid flow would blow the material away from its original track, but to provide a well-defined high-speed fluid flow, the velocity gradient of which induces a force, which again drags the material towards a maximum of the velocity gradient and thereby change the path of the material in a desired manner. In addition, even if the fluid flow is the high-speed fluid flow, it does not consume a lot of energy, because the diameters of the outputs are relatively small and thus the volume flow rate of the high-speed fluid flows is very low. In addition, a response time of the fluid flow providing device as well as the high-speed fluid flow is very short again due to the small volume flow rates.

The exemplary embodiments presented in this text are not to be interpreted to pose limitations to the applicability of the appended claims. The verb “to comprise” is used in this text as an open limitation that does not exclude the existence of also unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

### BRIEF DESCRIPTION OF THE DRAWINGS

Next the invention will be described in greater detail with reference to exemplary embodiments in accordance with the accompanying drawings, in which:

FIG. 1 illustrates a side view of an exemplary arrangement for controlling a path of material or filaments transferred by a transferring device according to an advantageous embodiment of the invention,

FIG. 2 illustrates a top view of an exemplary arrangement for controlling a path of filaments transferred by a transferring device according to an advantageous embodiment of the invention,

FIG. 3 illustrates a principle of an exemplary embodiment of the invention for controlling a path of filaments,

FIG. 4 illustrates the operating principle of the invention with a single flow providing device applied in controlling the path of a filament according to an advantageous embodiment of the invention,

FIGS. 5-7 illustrate examples of a fluid flow providing device according to an advantageous embodiment of the invention, and

FIGS. 8-9 illustrate top views of exemplary arrangements for controlling a path of filaments transferred by a transferring device according to an advantageous embodiment of the invention.

### DETAILED DESCRIPTION

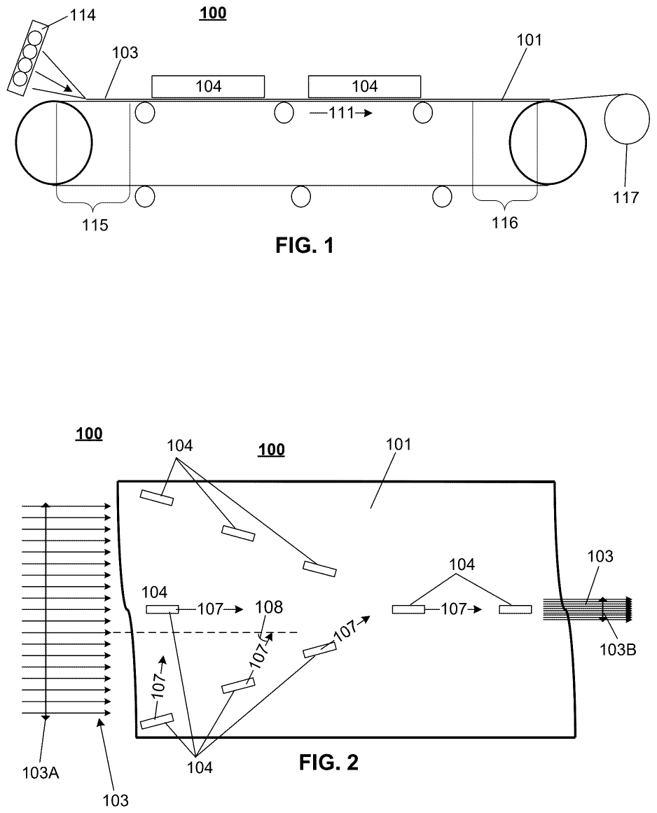

FIG. 1 illustrates a side view and FIG. 2 a top view of an exemplary arrangement 100 for controlling a path 102 of material or filaments 103 transferred by a transferring device 101 according to an advantageous embodiment of the invention. In these examples illustrated in Figures the material is advantageously filaments 103 or filament fibers and the transferring device 101 is a belt conveyor 101, an outer surface of which is configured to be faced against the received filaments. As an example, the filaments 103 are received into an input area 115 of the belt conveyor from number of filament providing nozzles 114. The belt conveyor 101 transfers the filaments 103 from the input area 115 to an output area 116 in a first direction of travel 111 of the belt conveyor 101, from where the filaments 103 are typically forwarded again to some further processing, such as a winding device 117 for winding the dried filaments 103. The transferring speed in the direction of the travel 111 of the filaments 103 is caused by the belt conveyor.

The arrangement 100 comprises one or more fluid flow providing devices 104 for providing and focusing one or more high-speed fluid flow 107 towards the material 103, as can be seen in FIG. 2. The flow rate of the fluid flow 107 is advantageously controllable and the speed of the high-speed fluid flow 107 is at a range of 50-330 m/s, more advantageously 50-200 m/s or 100-150 m/s, whereupon the transferring speed in the direction of travel 111 of the filaments 103 is typically 10-20 m/s. The fluid flow providing device 104 comprises at least one output 106 to provide the high-speed fluid flow 107. In addition, the output 106 and/or the fluid flow providing devices 104 can be adjusted and controlled so that the high-speed fluid flow 107 hits the transferring direction of the filaments at a certain desired angle 108 (angle of attack), which can be varied depending on the needs.

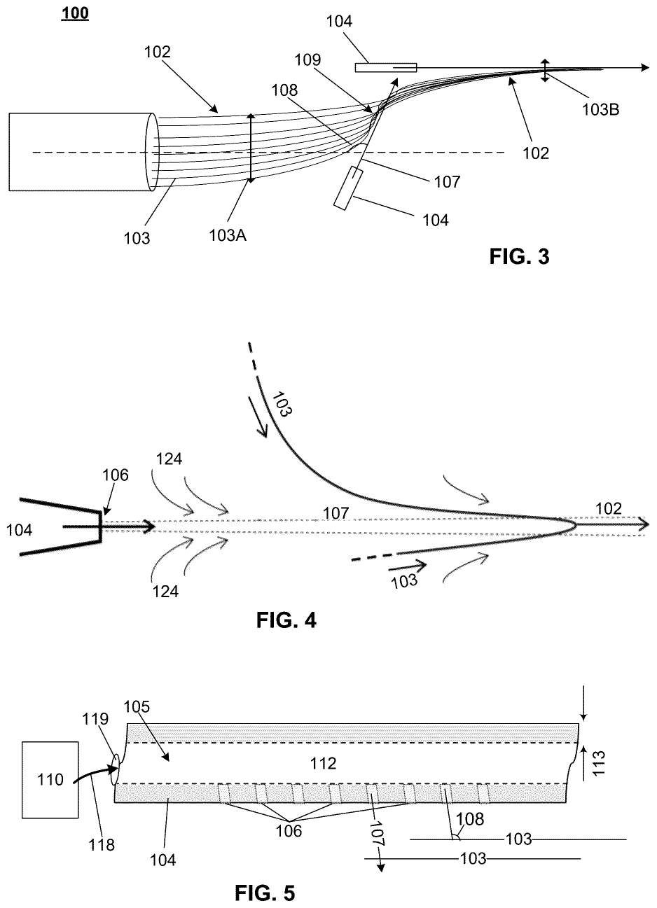

FIG. 3 illustrates a principle of an exemplary embodiment of the invention for controlling the path 102 of filaments 103, where the speed of the high-speed fluid flow 107 is higher than the transferring speed of the filaments 103, whereupon a velocity gradient of the high-speed fluid flow 107 induces a force 109, which drags the filaments 103 towards a maximum of the velocity gradient and thereby change the path 102 of the filaments 103 in a desired manner, as can be seen in FIG. 3, for example. In addition, the velocity gradient of high-speed fluid flow 107 causes compressing of the filaments closer to each other or towards the maximum of the velocity gradient of the high-speed fluid flow 107 as can be seen in FIGS. 2, 3 and 8, and the operating principle in FIG. 4, for example, where the width of the filament bundle 103A before the high-speed fluid flow 107 is wider than after 103B.

FIG. 4 illustrates the operating principle of the invention with a single flow providing device 104 applied in controlling the path of a filament according to an advantageous embodiment of the invention. The fluid flow providing device 104 with the output 106 provides the high-speed fluid flow 107, which induces the force to drag the material, like filaments 103, as well as an ambient fluid entrained 124 towards a maximum of the velocity gradient, and thereby change the path 102 of the material in a desired manner.

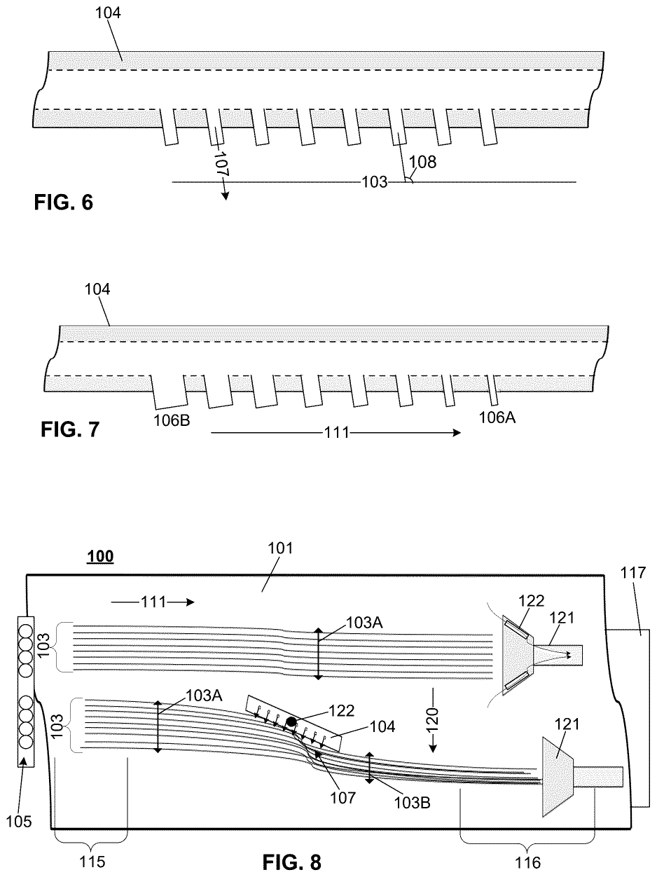

FIGS. 5-7 illustrate examples of a fluid flow providing devices 104 according to an advantageous embodiment of the invention. The exemplary fluid flow providing device 104 comprises a pipe with an input 105 for receiving pre-fluid flow 118, such as pressurized air, one or more outputs 106, and an inner fluid conduit 112 between the input 105 to the outputs 106. The outputs 106 may be implemented e.g. by capillary tubes extending from the pipe, as in FIGS. 5 and 6, or by capillary holes extending from the conduit 112 and through a pipe wall 113 to an outer surface of the pipe, as in FIG. 5. In addition, the arrangement comprises a connector 119 to a pre-fluid flow generating device, such as an air compressing device 110 for providing compressed air to the input 105 of the fluid flow providing device 104. As can be seen in FIG. 7, the outputs 106 may have different diameters 106A, 106B.

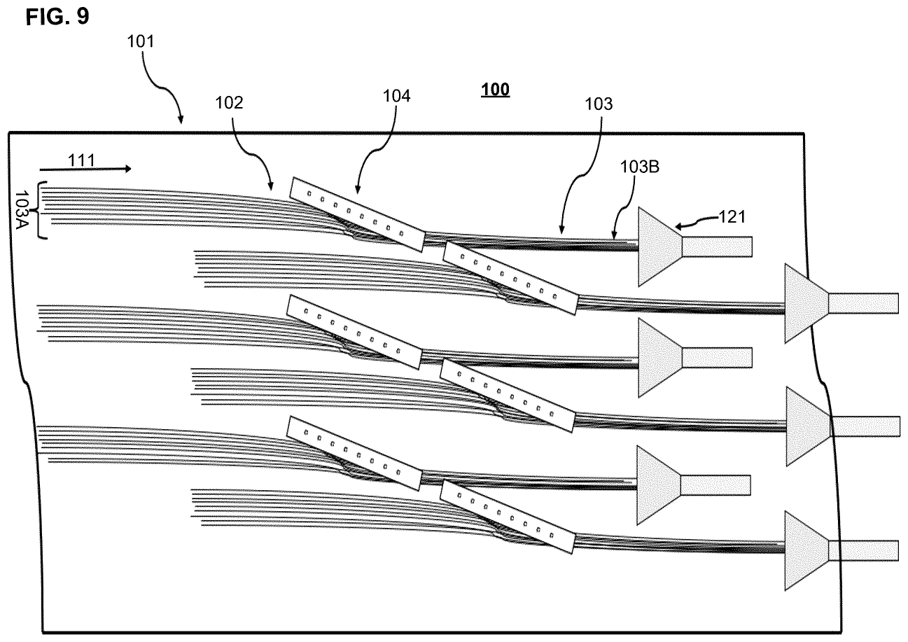

FIGS. 8-9 illustrate top views of exemplary arrangements 100 for controlling the path of filaments 103 transferred by a transferring device 101 according to an advantageous embodiment of the invention. The filaments 103 are received from a number of nozzles 114 to a number of lines on the surface of the belt conveyor 101. The lines of filaments are at the beginning (so in the input area 115) essentially parallel with the first direction 111 of travel of the belt conveyor 101. As can be seen, the fluid flow providing device 104 with the outputs 106 are used to provide the high-speed fluid flow 107 to change the path 102 of the filaments 103, so to cause a velocity component in a lateral direction 120 or to a second direction 120, said second direction 120 being perpendicular to or deviating from the direction of the travel 111, so from the first direction 111.

In addition, the arrangement 100 may comprise also a collecting device 121 for collecting the filaments at the output area 116. As can be seen in FIG. 8, the one fluid flow providing device 104 can be used for separating and dividing the great number of filaments 103 to two separate bundles and to two separate collecting devices 121. The collecting device 121 may comprise a pressure manipulating device 122 for decreasing pressure in the collecting device 121 thereby causing a sucking effect separately for each separate bundles. According to an example, the pressure manipulating device 122 may be implemented by the fluid flow providing device 104 directing the high-speed fluid flow in a suitable way, such as providing an ejector effect, so to accelerate the flow or travel speed of the filaments inside the collecting device essentially in the direction of the travel 111.

The FIG. 9 illustrates an example, where the arrangement 100 comprises number of the fluid flow providing devices 104 for separating the great number of filaments 103 to number of separate bundles and to number of separate collecting devices 121. The fluid flow providing devices 104 can be arranged sequentially in the direction of the travel 111 so that they do not interfere with each other.

In addition, according to an embodiment the arrangement may comprises also a manipulator 123 for turning the fluid flow providing device 104 around its axis or move the fluid flow providing device 104 in the first and/or second directions 111, 120 and thereby adjust the fluid flows in a desired manner in relation to the transferring device 101 and/or the material 103 transferred.

The invention has been explained above with reference to the aforementioned embodiments, and several advantages of the invention have been demonstrated. It is clear, that the invention is not only restricted to these embodiments only, but for example, even if the filaments are described in connection with the Figures, it is to be understood that also paths of other types of material could be controlled by the invention. In addition, even if the pressurised air is mentioned as an example of the high-speed fluid flow, also other types of fluids can be used, such as nitrogen, for example. In addition, even if the material is transferred by the belt conveyor, also other types of transferring devices can be used, such as a rolling cylinder. Furthermore, the path or trajectory of the material can be controlled even if the material is in the air and not supported by any transferring device.

The features recited in dependent claims are mutually freely combinable unless otherwise explicitly stated.

1. An arrangement for controlling a path of material, such as filaments, during transferring the material
wherein the arrangement comprises
at least one fluid flow providing device, wherein said least one fluid flow providing device comprises an input for receiving pre-fluid flow, and at least one output for providing and focusing at least one high-speed fluid flow towards the material transferred, wherein a speed of the high-speed fluid flow is configured to be at least 2 times higher than a transferring speed of the material, whereupon a velocity gradient of the high-speed fluid flow is configured to induce a force dragging the material towards a maximum of said velocity gradient and thereby change the path of the material due to the dragging force of the high-speed fluid flow.

2. The arrangement of claim 1, wherein the material is transferred by a transferring device, an outer surface of which is configured to be faced against the material to be received and transferred, and wherein the transferring speed of the material is caused by the moving transferring device.

3. The arrangement of claim 1, wherein the fluid flow providing device is a fluid conduit having number of said outputs along said fluid conduit.

4. The arrangement of claim 1, wherein the output of the fluid flow providing device comprises a nozzle for controlling direction and/or speed of the high-speed fluid flow from the nozzle.

5. The arrangement of claim 1, wherein the output of the fluid flow providing device has an inner diameter of 0.5-5 mm.

6. The arrangement of claim 1, wherein a flow rate of the fluid flow provided by the fluid flow providing device is controllable and wherein the speed of the high-speed fluid flow is 50-330 m/s.

7. The arrangement of claim 1, wherein the speed of the fluid flow provided by the fluid flow providing device is configured to decrease so that 10 cm from the output the fluid flow providing device, the speed of the fluid flow is smaller than the speed of the material, where the speed of the material is due to the transferring device.

8. The arrangement of claim 1, wherein the arrangement comprises an air compressing device for providing compressed air as said pre-fluid flow to the input of the fluid flow providing device.

9. The arrangement of claim 1, wherein the arrangement is configured to use said high-speed fluid flow as a carrier flow fluid for additives.

10. The arrangement of claim 1, wherein a direction of the high-speed fluid flow of the at least one output of the fluid flow providing device is controllable so to provide the high-speed fluid flow with a certain angle of attack in relation to a direction of travel of the transferring device or material transferred.

11. The arrangement of claim 10, wherein the fluid flow providing device comprises a socket and a ball shaped nozzle with the output, wherein said nozzle is arranged to said socket so that the ball shaped nozzle and thus the direction of the output of the ball shaped nozzle is controllable.

12. The arrangement of claim 1, wherein the arrangement comprises outputs with different diameters, where smaller diameter outputs are arranged in a downstream in the direction of the travel of the transferring device and greater diameter outputs are arranged in an upstream in the direction of the travel of the transferring device.

13. The arrangement of claim 1, wherein the fluid flow providing device comprises a pipe with an inner fluid conduit between the input to the outputs and wherein the outputs are implemented by capillary tubes extending from the pipe in an angle.

14. The arrangement of claim 1, wherein the fluid flow providing device comprises a pipe with an inner fluid conduit between the input to the outputs and relatively thick wall and wherein the outputs are implemented by capillary holes extending from the conduit and through the pipe wall in an angle to an outer surface of the pipe.

15. A method for controlling a path of material during transferring the material by a transferring device,
wherein the method comprises steps of:
receiving pre-fluid flow to a fluid flow providing device, said fluid flow providing device comprising at least one output,
providing and focusing a number of high-speed fluid flows from said output towards the material transferred, wherein a speed of said high-speed fluid flows is at least 2 times higher than the transferring speed of the material, and
inducing a dragging force by the velocity gradient of the high-speed fluid flow to the material towards a maximum of said velocity gradient and thereby changing the path of the material.

16. The method of claim 15, wherein a flow rate of the fluid flow provided by the fluid flow providing device is controlled and wherein the speed of the high-speed fluid flow is 50-330 m/s.

17. The method of claim 15, wherein the speed of the fluid flow provided by the fluid flow providing device decreases so that the speed of the fluid flow is smaller than the speed of the material after 10 cm from the output the fluid flow providing device.

18. The method of claim 15, wherein said fluid flow is used as a carrier flow fluid for additives in order to guide the additives to the same location as the material transferred.

19. The method of claim 15, wherein an angle of attack of at least one of said high-speed fluid flows in relation to direction of the transferred material deviates from zero.
